(19) United States
(12) Patent Application Publication
(10) Pub. No.: US 2010/0145882 A1
(43) Pub. Date: Jun. 10, 2010

(54) METHOD AND SYSTEM FOR SECURELY TRANSFERRING THE PERSONALITY OF A POSTAL METER AT A NON-SECURE LOCATION

(75) Inventors: John S. Wronski, JR., Shelton, CT (US); Catherine C. Morrissey, Woodbridge, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/332,101

(22) Filed: Dec. 10, 2008

(51) Int. Cl. G06F 12/16

(52) U.S. Cl. 705/405

(57) ABSTRACT

A method and system for securely transferring the personality of a postage meter system to a replacement postage meter system at a non-secure location includes the steps of connecting a security tool to the postage meter system at the non-secure location and the tool retrieving data from the postage meter system. The tool signs the retrieved data. The tool is connected to a data center and the tool transmits the signed data to the data center. The data center validates the signature and content of the retrieved data and the data center signs replacement adjusted data and transmits the signed replacement adjusted data from said data center to the tool at non-secure location. The tool sends the signed replacement adjusted data to the replacement postage meter system and the replacement postage meter system validates and installs the signed replacement adjusted data in the postage meter system at the non-secure location.

### FIELD OF THE INVENTION

The invention disclosed herein relates generally to the management of postal meter systems, and more particularly, to a method and system for securely transferring the personality of a postal meter at a non-secure location.

### BACKGROUND OF THE INVENTION

Postage meters print and account for postage imprinted on mail pieces. Postal meters systems are of various designs and include designs with discrete components. One such arrangement includes a user interface controller (UIC), postal security device (PSD) and a printer for printing postage. The UIC has a keyboard and display with the secure PSD housed within the UIC. The UIC is detachably connected to a base that contains the printer for printing postage and a transport for transporting media such as envelopes to the printer. The base operates under control of the UIC. Such postal meter systems are often connected via a communication link, such as the Pitney Bowes Intellilink from a user's site to a data center such as a Pitney Bowes data center.

Although postage meter systems are generally reliable, postage meter systems may fail to operate properly. The types of malfunction can include defective keyboards, defective displays, communications failures between the meter and the data center where communication keys involved in the encrypting and signing of the communications get out of synchronism between the data center and the postage meter system or the UIC and PSD. In cases where postage meters fail to operate properly, it is usual for the manufacturer to take the faulty postage meter system out of service (usually the UIC and PSD), return the defective postage meter system to a secure location and provide the user with a new postage meter system or UIC and PSD, as the case may be. This process of providing a new postage meter is employed so as to avoid problems associated with downtime for the mailer which would adversely affect the mailer's operations such as delaying the mailing of invoices, advertising literature and the like.

Depending on the configuration of the meter, it may be possible for a technician to retain the UIC and the meter printer at the user site, remove the defective PSD and replace the defective PSD with a properly operating PSD. However, in such case the UIC, PSD and data center would be out of synchronism and the postage meter system would not properly operate. Whether, the entire postage meter system is replaced or only the defective UIC/PSD is replaced, vital information stored in the defective postage meter system or defective UIC/PSD is lost to the user. This includes departmental accounting information where various departments or categories are charged for the use of postage and also various job presets. The departmental accounting could involve numerous categories and the preset job run setting can involve numerous configurations picked from various options for dozens of preset jobs which are run by the mailer. Thus, the user has to reintroduce into the new postage meter system or into the new UIC/PSD, the various departmental accounts and the various job run settings. Examples of the parameters that are preset for various job runs include postage class selection, date formatting, graphic selection, fee selection, language selection, weight selection, machine operating mode (key in postage, weigh first piece, manual weight entry), smartclass settings (weight/class breaks) and accounting parameters.

The postal funds in the replacement postage meter system or replacement UIC/PSD is reconstructed from the data center transaction logs to determine money transferred between the users account, data center and the defective postage meter system. Postage meter systems in many countries periodically communicate with the data center in predetermined periods such as thirty (30) or ninety (90) days to transmit the activity log of the postage meter system. This data is also available for reconstructing the amount of money which may remain in the defective postage meter system or defective UIC/PSD which have been taken out of service. These reconstructed funds are credited to the user's account.

As a consequence of the above, while the mailer may be credited with the reconstructed funds, the mailer still needs to reset all of the parameters for the replacement postage meter system or replacement UIC/PSD including the departmental accounting and the job run settings. This can involve many hours or days of work. For example, the Pitney Bowes postage meter system DM1000 Series model meters allows for two thousand different departmental accounts with the capacity for four thousand sub-accounts providing a maximum capacity of six thousand total accounts within the system. Additionally, the meter allows for 25 preset jobs with each preset job potentially having 25 preset parameters including those identified above.

The postage meter system or UIC/PSD, as the case may be, is taken back to a secure facility where it is processed. Such a secure facility typically is physically secured for the processing of postage meters and is inspected by and approved by the government postal authorities. Additionally, the secure facility is operated by people who are approved for this function to insure the integrity and security of the data extracted from or entered into the postage meter system or UIC/PSD.

The processing at the secure facility may include extraction of information from the memory of the postage meter system or UIC/PSD to determine the nature of the fault and to verify various information within the meter. Where desired, when the information is removed from the postage meter system or UIC/PSD if it is sufficient, it can be used at the secure location to clone another postage meter system or UIC/PSD. However, this is typically not done since the user has already been provided with a replacement postage meter system or UIC/PSD. Often the defective components in the postage meter system are physically destroyed at the secure location. The present process described above is very costly involving new replacement postage meter systems or UIC/PSDs as well as the cost and time to bring the defective equipment to a secure facility for further processing and especially the time, effort and lost ability for mailer for mailers to properly run mail jobs until the personality of the defective meter or PSD is recreated.

### SUMMARY OF THE INVENTION

It is an object of the present invention to minimize those instances where a defective postage meter system or UIC/PSD is taken out of service by securely repairing or cloning the defective postage meter system, UIC/PSD or portion thereof at an non-secure location such as a user location.

It is another object of present invention to minimize the need for users of failed postage meter systems to have to reenter various information into replacement postage meter systems or UIC/PSDs.

It is yet another object of the present invention to provide a method and system for securely transferring data from a defective postage meter system or UIC/PSD to a replacement postage meter system or UIC/PSD at a non-secure location such as a meter user site.

A method for securely transferring the personality of a postage meter system to a replacement postage meter system at a non-secure location embodying the present invention includes the steps of connecting a security tool to the postage meter system at the non-secure location and the tool retrieving data from the postage meter system. The security tool signs the retrieved data. The security tool is connected to a data center and the tool transmits the signed data to the data center. The data center validates the signature and content of the retrieved data. The data center signs replacement adjusted data and transmits the signed replacement adjusted data from said data center to the security tool at the non-secure location. The security tool sends the signed replacement adjusted data to the replacement postage meter system and the replacement postage meter system validates and installs the signed replacement adjusted data in the replacement postage meter system at the non-secure location.

A system for securely transferring the personality of a postage meter system includes a first postage meter system including a UIC and a PSD and a second postage meter system including a UIC and a PSD. The system also includes a data center having data relating to the operation of the first postage meter system and a security tool having communication functionality for bidirectional secure communications with the first postage meter system, the second postage meter system and the data center. The security tool is connectable to the first postage meter system for secure bidirectional communication between the security tool and the first postage meter system, the security tool is connectable to the second postage meter system for secure bidirectional communication with the second postage meter system and the security tool is connectable to the data center for secure bidirectional communications with the data center. The security tool is operable to extract data from the first postage meter system, securely transmit the extracted data to the data center, securely receive replacement adjusted data from the data center and securely communicating the replacement adjusted data to the second postage meter system.

In accordance with a feature of the present invention, the replacement postage meter system, the second postage meter system, audits the installed replacement adjusted data with the data center to provide assurance that the components of the replacement postage meter system are in synchronism with each other and that the components are working together properly.

### DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. As shown throughout the drawings, like reference numerals designate like or corresponding parts.

FIG. 1 is a system for securely transferring the personality of a postage meter system at a non-secure user location to a replacement postage meter system embodying the present invention;

FIG. 2 is a flow chart of the operation of the system shown in FIG. 1 where a defective postage system meter includes a faulty UIC and a good PSD;

FIG. 3 is a flow chart of the operation of the system shown in FIG. 1 where a defective postage meter system contains a good UIC and a faulty PSD; and,

FIG. 4 is a flow chart of the operation of the system shown in FIG. 1 where a postage meter system has a faulty UIC and faulty PSD.

### DETAILED DESCRIPTION OF THE PRESENT INVENTION

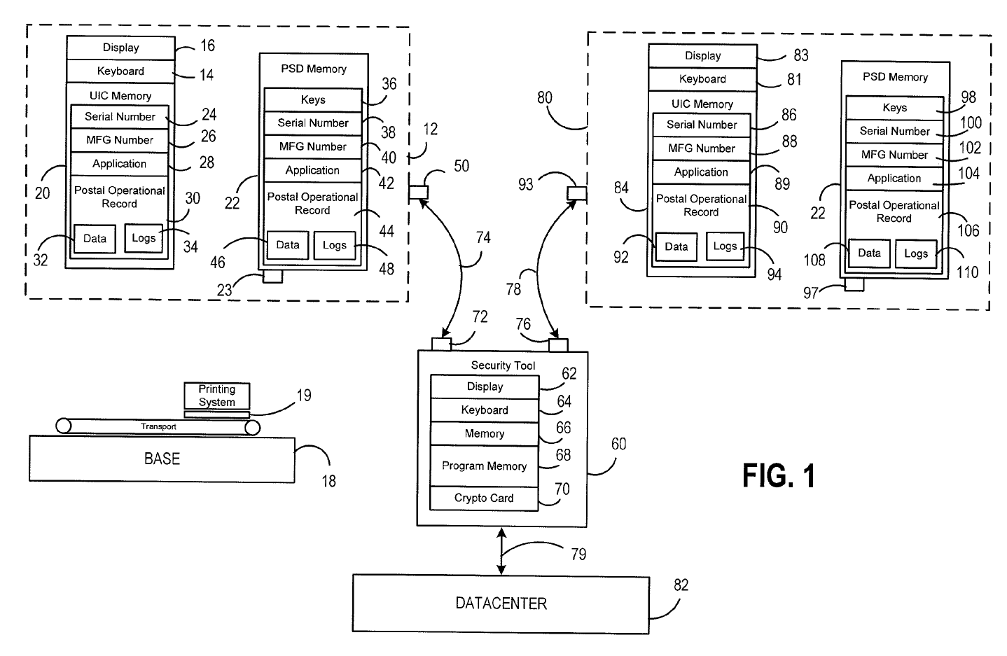

Reference is now made to FIG. 1 which shows a system for securely transferring the personality of a postage meter system at a non-secure user location to a replacement postage meter system. The replacement postage meter system is a postage meter system having at least one component that is different from the components in the postage meter system. The personality of a postage meter is the various settings of the postage meter systems such as preset job runs, the status of the various logs and registers and all of those items of data that are unique to the current condition of the postage meter system. This personality is to be transferred to the extent possible based on the nature of a defect in the postage meter system to a replacement postage meter system.

A postage meter system is shown generally at 10 and includes a UIC 12 which contains a keyboard 14 and a display 16. The UIC 12 is detachably connected to a base 18. The base 18 provides the system for transporting media such as envelopes to a print system for imprinting postage and other information on the media. One system of this type is the Pitney Bowes DM1000 postage meter system. The UIC 12 provides control of the operation of the base 18.

The UIC 12 includes a UIC memory 20 which is a non-secure memory system for the UIC and a PSD 21 which has a PSD memory 22. The PSD 21 is a secure device which contains critical postal accounting data including a descending register having postage value stored in the meter and available for printing postage. The UIC memory 20 includes a serial number 24 for the UIC, a manufacturing number 26, a program memory containing the application program for the UIC at 28 and various postal operational records 30. This includes data at 32 and various logs 34 of the operation of the UIC. The logs 34 include a shadow memory of the last 100 transactions of the UIC 12. This shadow memory is a shadow of the data stored in the PSD memory 22 and would include the printing of postage, the values of the ascending and descending register and other information reflecting the operation of the system. The PSD 22 memory includes various encryption and communication keys 36 serial number 38, manufacturing number 40, program memory containing application programs 42 and postal operation records 44 having data 46 and various operational logs 48. The PSD device 21 including the PSD memory 22 is the secure portion of the postage meter system 10. The UIC 12 includes a serial or other communications port 50 to enable the device to communicate externally to other devices. The PSD 21 contain a communication port such as a USB port 23 to allow the PSD within the UIC 12 to have bidirectional communication with other parts of the UIC 12 such as memory 20.

When the postage meter system is manufactured and made operational, the UIC 12 is configured such that a specific UIC operates in synchronism with a specific PSD. Moreover, the specific components have been configured to be in synchronism with the data center. Thus, the UIC 12 having the serial number 24 and the manufacturing number 26 is synchronized to work with the PSD 21 having serial number 38 and manufacturing number 40 and these two specific components are synchronized to work with the data center.

When a postage meter system is not operating properly due to problems in the UIC 12, the UIC is connectable to a security tool 60 which may be brought by a technician to a non-secure user location. The security tool 60 includes a display 62, a keyboard 64, a memory 66, a program memory 68 with application program and a cryptocard 70. Security tool 60 is also connectable over a communications channel 79 to a remote data center 82. The communications between the remote data center 82 and the security tool 60 are bidirectional encrypted secure communications. Encryption and signing is employed to ensure the security of the bidirectional communications. The cryptocard 70 within the security tool 60 provides this functionality for bidirectional secure communications. The tool may be a special purpose secure device or may be a laptop type computer with specific application programs.

A UIC 80 is brought to the user location by the technician. This UIC 80 is a blank UIC. The UIC 80 includes parallel type of structure to the UIC 12. UIC 80 includes a UIC memory 84 having serial number 86, manufacturing number 88, program memory with applications program 89, postal operational record 90 with data 92 and logs 94. The PSD 95 within the UIC 96 has a PSD memory 96. The PSD memory 96 includes communication keys 98, serial number 100, manufacturing number 102, a memory for applications programs 104, a postal operational record 106 with data 108 and logs 110. The UIC 80 also has a keyboard 81 and display 83. The UIC 80 includes a serial or other communications port 93 to enable the device to communicate externally to other devices. The PSD 95 contain a communication port such as a USB port 97 to allow the PSD within the UIC 80 to have bidirectional communication with other parts of the UIC 80 such as memory 84. The UIC 80 is essentially a blank UIC with all of the data and logs blank in both the UIC memory 84 and the PSD memory 96. This UIC 80 is available for cloning the personality of UIC 12 if needed in the manner described below.

The failure modes of the postage meter system 10 UIC 12 includes the possibility that the UIC 12 has failed, the PSD 21 has failed or both the UIC 12 and the PSD 21 have failed. The procedures for correcting these problems at the user site in a secure manner vary depending upon the nature of the problem.

Where the PSD 21 is functioning properly, the security tool 60 can transfer the data from the UIC memory 20 to the UIC memory 84 to create an image of the data in the UIC memory. This would be the case where for example the UIC memory is functioning properly but the display 16 or keyboard 14 are malfunctioning. In such case the transfer would occur and the PSD 21 would be removed from the UIC 12 and installed in the UIC 80. Thus, PSD 95 would be removed from UIC 80 and PSD 21 inserted. The tool security communicates with the data center securely such that the data center recognizes that the UIC 12 has been taken out of service and a new UIC 80 has been put in service with PSD 21 as part of that device with the UIC, PSD and data center all securely made to be in synchronism for proper operation of the repaired postage meter system. This process enables the serial and manufacturing numbers of the UIC 80 to be associated with the PSD 21 serial numbers 38 and manufacturing number 40. This is accomplished with securely synchronizing the UIC 80, the PSD 21 and data center such that communications and encryption keys as well as the data and logs are in full synchronism and the postage meter system operates properly.

In the instance where the UIC has completely failed such that the UIC memory cannot be transferred, the PSD 21 is removed from the UIC 12 and installed in the UIC 80 as a replacement for PSD 95. The information in the data memory 46 and the logs 48 are employed in conjunction with the data and logs at the data center 82 to securely reconstruct the information in the memory of the new UIC 84 to the extent possible based on available data and logs. In such instance, the departmental accounting information and the preset data are lost to the user however the accuracy of the accounting registers and the last 100 transactions are preserved. It should be note that when needed, the PSD USB port 23 can be employed to enable communications between PSD 21 and the security tool 60. Verification with the data center 82 is implemented to insure that the transferred information into UIC 84 memory is coherent and accurate, properly reflecting the status of the defective UIC 12 such as the accounting registers and transactions logs to the extent possible.

A situation can also exist where the UIC 12 has a failure of the PSD memory 22. In such case, the PSD 21 is removed from the UIC 12 and the PSD 95 is installed into UIC 12. The data is in the UIC memory 20 is used and securely transferred by the security tool 60 into the new PSD memory 96 in conjunction with the data and logs at the data center 82 to securely reconstruct the information in the memory of the new PSD memory 96 to the extent possible based on available data and logs. Verification with the data center 82 is implemented to insure that the transferred information into PSD memory 96 is coherent and accurate, properly reflecting the status of the UIC 12 such as the accounting registers and transactions logs.

Where both the UIC memory 20 and the PSD memory 22 are defective, the tool is capable of causing the UIC 80 to be rendered operational by securely transferring data from the data center 82. This transfer is based on operational logs and records at the data center through the tool 60 and into the UIC memory 84 and the PSD memory 96. The UIC is then rendered operable at the non-secure user location with securely reconstructed data to the extent possible based on available data and logs in both the UIC memory 84 and the PSD memory 96. Verification with the data center 82 is implemented to insure that the transferred information into UIC memory 84 and the PSD memory 96 is coherent and accurate, properly reflecting the status of the defective UIC 12 and PSD memory 22 to the extent possible.

The data center processes received signed data extracted from the defective postage meter system, a first postage meter system, in reconstructing data, the replacement adjusted data, for use in the replacement postage meter system, a second postage meter system. The data center in creating the replacement adjusted data includes data and logs from the data center and also to the extent the received data from the defective postage meter system is coherent and accurate and consistent with the data center data and logs, the received data from the defective postage meter system. This coherent and accurate data (data and logs) which is consistent with the data center data and logs, depending on the nature of the defects in the postage meter system, may include data from components which are not faulty, components which are faulty and/or both not faulty and faulty components. Thus, to the greatest extent possible, the data and logs from the defective postage meter system UIC and PSD along with data and logs from the data center are used to create the replacement adjusted data employed to transfer the personality of the defective postage meter system, first postage meter system to the replacement postage meter system, second postage meter system.

Reference is now made to the various flow charts which describe the process for each of the instances of meter failure mode described above.

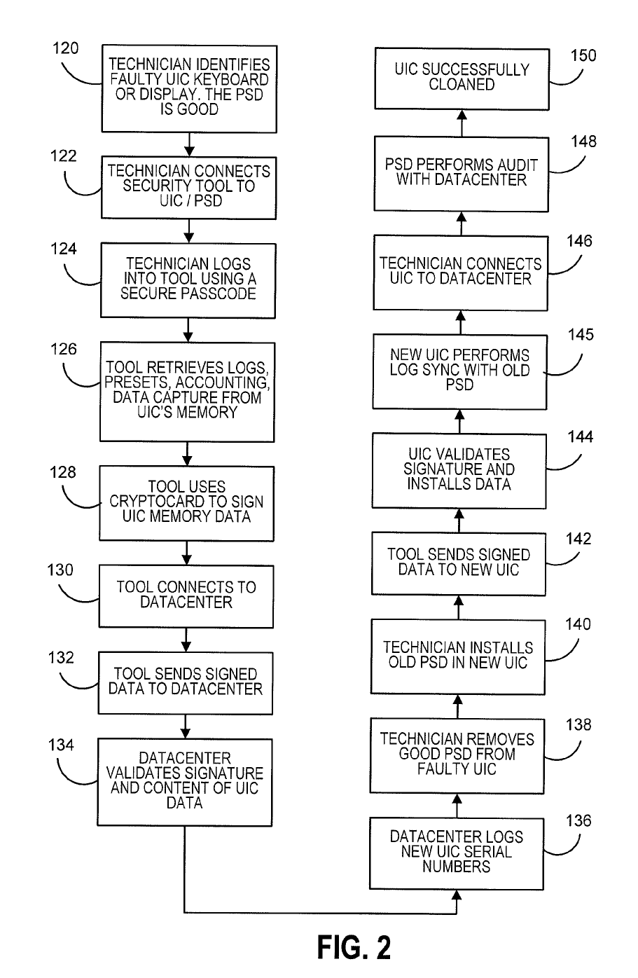

Reference is now made to FIG. 2. FIG. 2 shows the flow chart of the operation of the system shown in FIG. 1 where a defective postage meter system includes a faulty UIC and a good PSD. At 120 the technician identifies a faulty UIC keyboard or display and determines that the PSD is good. It should be noted that there can be other defects in the UIC and designation of the keyboard or display as being faulty is just an example of the type of problems that can be encountered with a UIC. At block 122 the technician connects the security tool to the UIC/PSD. At block 124 the technician logs into the tool using a secure pass code. Other forms of security can be employed to provide assurance that the tool is being used by an authorized person in the proper manner.

At block 126 the tool retrieves the various logs, presets, accounting data, accounting information and other data capture from the UIC memory. The tool at block 128 uses the cryptocard to sign the UIC memory data and at block 130 the tool connects to the data center.

The tool sends the signed data to the data center at block 132 and the data center validates the signature and content of the UIC data at block 134. The process continues with the data center logging the new UIC serial numbers being obtained at block 136 and at block 138 the technician removes the good PSD from the faulty UIC. The technician then installs the old PSD in the new UIC at block 140. The tool sends the signed data to the new UIC at block 142 and the UIC (thru the PSD validation services) validates the signature and installs the data at block 144. At block 145 the new UIC performs a log synchronization function with the old PSD. This is to ensure that the logs transferred from the old UIC to the new UIC are in synchronism with the old PSD which data should be accurate. This function, of course, is not needed in the situation where the UIC is good and the PSD is faulty or the UIC is faulty and the PSD is also faulty. In the first case where the UIC is good and the PSD is faulty, the UIC logs should not be corrupted, and in the second case where the UIC is faulty and the PSD is faulty, all new information is loaded from the data center. This establishes and verifies synchronism.

The technician connects the UIC to the data center at block 146. The PSD performs its secure audit with the data center at block 148. The secure audit function involving taking the various data stored in the PSD signing them, transmitting them to the data center where the data center verifies that the information in the PSD is accurate and consistent with the data at the data center. The PSD secure audit of the various registers in the PSD with the data center provides assurance that the UIC and the PSD are in synchronism with each other and with the data center and that the UIC and PSD are working properly together. Once this is determined, the UIC is deemed to be successfully cloned at block 150. At the point of the UIC being successfully cloned, records have been updated due to the secure audit process both in the data center and in the UIC/PSD.

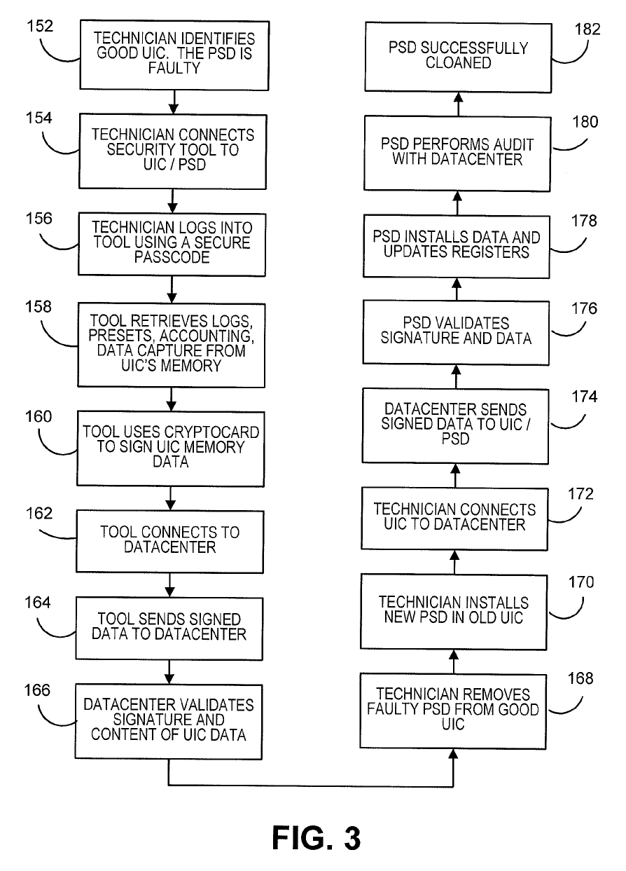

Reference is now made to FIG. 3. FIG. 3 is a flow chart of the operation of the system shown in FIG. 1 where a faulty meter contains a good UIC and a faulty PSD. At block 152 the technician identifies the good UIC and the faulty PSD. The technician at block 154 connects the security tool to the UIC/PSD. At block 156 the technician logs into the security tool using a pass code. As previously noted other forms of security can be employed. At block 158 the tool retrieves the logs, presets, accounting and other data capture from the UIC memory. The tool then uses the cryptocard to sign the UIC memory data at block 160. The tool connects to the data center at block 162 and sends signed data to the data center at block 164.

At block 166 the data center validates the signature and content of the UIC data. Then, at block 168 the technician removes the faulty PSD from the good UIC and installs the new PSD in the old UIC at block 170. The technician connects the UIC to the data center at block 172 and the data center sends signed data to the UIC/PSD at block 174. The PSD validates the signature and data received at block 176 and the PSD installs and updates the PSD registers at block 178.

At block 180 the PSD performs a secure audit with the data center in the manner previously noted in connection with FIG. 2. The PSD secure audit of the various registers in the PSD with the data center provides assurance that the UIC and the PSD are in synchronism with each other and with the data center and that the UIC and PSD are working properly together. At block 182 the PSD is deemed to be successfully cloned. At the point of the PSD being successfully cloned, records have been updated due to the secure audit process both in the data center and in the UIC/PSD.

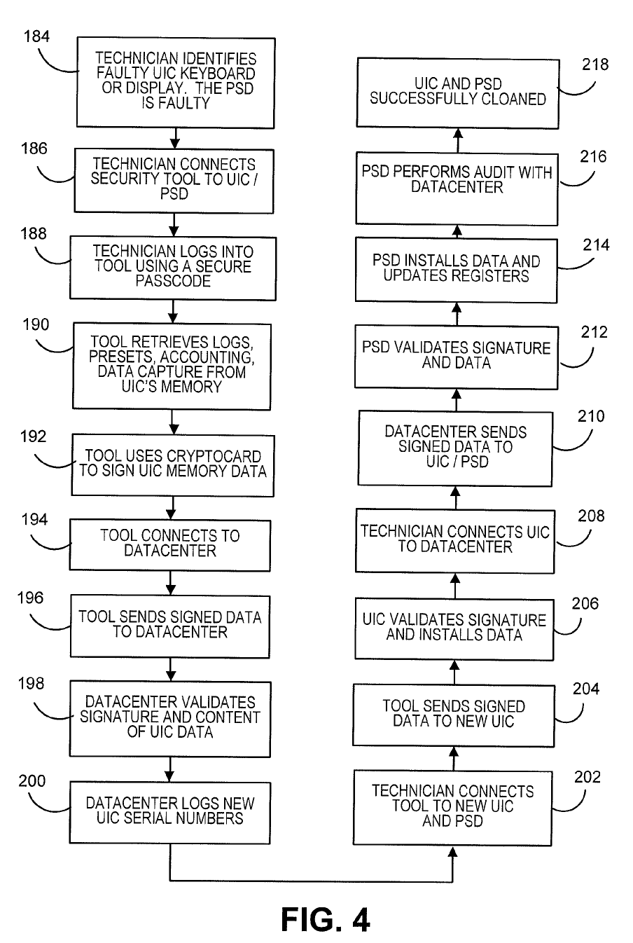

Reference is now made to FIG. 4. FIG. 4 is a flow chart of the operation of the system shown in FIG. 1 where a postage meter system has a faulty UIC and faulty PSD. At block 184 the technician identifies the faulty UIC and the faulty PSD. At block 186 the technician connects the security tool to the UIC/PSD and the technician logs into the tool using a secure pass code at block 188. As previously noted other forms of security can be employed.

At block 190 the tool retrieves the logs, presets, accounting, and other data captured from the UIC's memory. At block 192 the tool uses the cryptocard to sign the UIC memory data and at 194 the tool connects to the data center. The tool sends the signed data to the data center at block 196 and the data center validates the signature and the content of the UIC data at block 198. At block 200 the data center logs the new UIC serial numbers.

At block 202 the technician connects the tool to the new UIC and new PSD. The tool sends the signed data to the new UIC at block 204 and the UIC (thru the PSD validation services) validates the signature and installs the data at block 206. At block 208 the technician connects the UIC to the data center. The data center sends signed data to the new UIC and new PSD at block 210. At block 212 the PSD validates the signature and data received from the data center through the UIC. At block 214 the PSD installs the data and updates the registers. The PSD performs the secure audit function with the data center at block 216 in the manner previously described in connection with FIGS. 2 and 3. The PSD secure audit of the various registers in the PSD with the data center provides assurance that the UIC and the PSD are in synchronism with each other and with the data center and that the UIC and PSD are working properly together. At block 218 the new UIC and PSD are deemed successfully cloned. At the point of the UIC and PSD being successfully cloned, records have been updated due to the secure audit process both in the data center and in the UIC/PSD.

The above system enables the personality of a postage meter system to be transferred to a replacement postage meter system to the extent possible at a non-secure location. Thus, the above system permits a defective postage meter system or UIC/PSD to be securely processed at a non-secure location such as a customer site. The system enables the secure transfer of stored data from the defective device to a replacement postage meter system or replacement UIC/PSD or portion thereof under many varying situations beyond the specific examples given above. Because data is taken out of the defective postage meter system or UIC/PSD and is securely transmitted to the data center where it is processed to insure its integrity, the defect in the defective postage meter system or UIC/PSD, whatever it might be, is worked around employing the tool to access when possible the data within the defective postage meter system or defective UIC/PSD. This work around can be accomplished, for example, by either using messages that have not failed where for example a number of communications messages are not operating properly but other messages within the PSD are operating properly or where communication keys are out of synchronism with the data center and where engineering keys within the PSD can be utilized to extract and verify the integrity of the data being extracted. These may be engineering keys in the PSD that are still operative as opposed to the out of synchronism and inoperative communication keys. The data securely taken out of the defective UIC/PSD and sent back to the data center can be analyzed at the data center to determine whether the defect is of the type that can be corrected in the field. If the data center determines that the extracted data is coherent and valid, that is the extracted data is accurate, the data center communicates back to the tool to provide the data to be loaded into a new UIC/PSD. This securely saves and securely employs all of the available information in the defective UIC/PSD, such as funds available for printing postage, departmental accounting information and various logs, encryption keys and the like whenever possible. Thus, the data center processes the retrieved data and data related to the postage meter system at the data center to create and sign replacement adjusted data. This reconstructs, to the greatest extent possible, the data in the defective postage meter system. The data center transmits the signed replacement adjusted data from the data center to said security tool for use at the non-secure location.

While the present invention has been disclosed and described with reference to a single embodiment thereof, it will be apparent, as noted above that variations and modifications may be made therein. It is, thus, intended in the following claims to cover each variation and modification that falls within the true spirit and scope of the present invention.

What is claimed is:

1. A method for securely transferring the personality of a postage meter system to a replacement postage meter system at a non-secure location comprising the steps of:
connecting a security tool to said postage meter system at said non-secure location;
said security tool retrieving data from said postage meter system and said tool signing said retrieved data;
connecting said security tool to a data center and transmitting said signed data to said data center;
validating said signature and content of said retrieved data at said data center;
said data center signing replacement adjusted data and transmitting said signed replacement adjusted data from said data center to said security tool at said non-secure location;
said security tool sending said signed replacement adjusted data to said replacement postage meter system; and,
said replacement postage meter system validating and installing said signed replacement adjusted data in said replacement postage meter system at said non-secure location.

2. A method for securely transferring the personality of a postage meter system to a replacement postage meter system at a non-secure location as defined in claim 1 comprising the further step of said replacement postage meter system securely auditing said installed replacement adjusted data with said data center.

3. A method for securely transferring the personality of a postage meter system to a replacement postage meter system at a non-secure location as defined in claim 2 wherein said postage meter system is of the type having UIC component and a PSD component and wherein said replacement postage meter is of the type having a UIC component and a PSD component.

4. A method for securely transferring the personality of a postage meter system to a replacement postage meter system at a non-secure location as defined in claim 3 wherein said postage meter system has at least one faulty component and said replacement postage meter system includes at least one component from said postage meter system and one different component from said postage meter system.

5. A method for securely transferring the personality of a postage meter system to a replacement postage meter system at a non-secure location as defined in claim 3 wherein said postage meter system has a faulty UIC component and said replacement postage meter system includes said PSD component from said postage meter system and a different UIC component from said postage meter system.

6. A method for securely transferring the personality of a postage meter system to a replacement postage meter system at a non-secure location as defined in claim 5 wherein said replacement adjusted data includes data from said postage meter PSD and data and logs from said data center to securely reconstruct data from said postage meter system in said replacement postage meter system.

7. A method for securely transferring the personality of a postage meter system to a replacement postage meter system at a non-secure location as defined in claim 3 wherein said postage meter system has a faulty PSD component and said replacement postage meter system includes said UIC component from said postage meter system and a different PSD component from said postage meter system.

8. A method for securely transferring the personality of a postage meter system to a replacement postage meter system at a non-secure location as defined in claim 7 wherein said replacement adjusted data includes data from said postage meter UIC and data and logs from said data center to securely reconstruct data from said postage meter system in said replacement postage meter system

9. A method for securely transferring the personality of a postage meter system to a replacement postage meter system at a non-secure location as defined in claim 3 wherein said postage meter system has a faulty PSD component and a faulty UIC component and said replacement postage meter system includes a different PSD component from said postage meter system and a different UIC component from said postage meter system.

10. A method for securely transferring the personality of a postage meter system to a replacement postage meter system at a non-secure location as defined in claim 9 wherein said replacement adjusted data includes data and logs from said data center to securely reconstruct data from said postage meter system in said replacement postage meter system.

11. A method for securely transferring the personality of a postage meter system to a replacement postage meter system at a non-secure location as defined in claim 3 wherein said replacement postage meter system PSD component performs said secure audit function with said data center.

12. A method for securely transferring the personality of a postage meter system to a replacement postage meter system at a non-secure location as defined in claim 11 wherein said data center renders said replacement postage meter system operative when said secure auditing function determines that said components of said replacement postage meter components are in synchronism with each other and in synchronism with said data center.

13. A method for securely transferring the personality of a postage meter system to a replacement postage meter system at a non-secure location comprising the steps of:
connecting a security tool to said postage meter system at said non-secure location, first postage meter system containing data;
said tool retrieving said data from said postage meter system and said security tool signing said retrieved data;
connecting said security tool to a data center and transmitting said signed data to said data center;
validating said signature and content of said retrieved data at said data center;
said data center processing said retrieved data and data related to said postage meter system at said data center to create and sign replacement adjusted data to reconstruct said data in said first postage meter system and transmitting said signed replacement adjusted data from said data center to said security tool at said non-secure location;
said security tool sending said signed replacement adjusted data to said replacement postage meter system; and,
said replacement postage meter system validating and installing said signed replacement adjusted data in said replacement postage meter system at said non-secure location whereby said personality of said first postage meter is securely transferred to said replacement postage meter.

14. A method for securely transferring the personality of a postage meter system to a replacement postage meter system at a non-secure location as defined in claim 13 wherein said retrieved data from said postage meter system includes data and logs and said data at said data center include data and logs.

15. A method for securely transferring the personality of a postage meter system to a replacement postage meter system at a non-secure location as defined in claim 13 wherein said data center processing said retrieved data includes determining that said retrieved data is coherent and accurate and consistent with data at said data center.

16. A method for securely transferring the personality of a postage meter system to a replacement postage meter system at a non-secure location as defined in claim 13 wherein said postage meter system includes a UIC and a PSD and wherein data center processing said retrieved data includes determining that said retrieved data is coherent and accurate and consistent with data at said data center.

17. A method for securely transferring the personality of a postage meter system to a replacement postage meter system at a non-secure location as defined in claim 16 wherein said retrieved data from said postage meter system includes data and logs and said data at said data center include data and logs and wherein said data center processing said retrieved data includes determining that said retrieved data is coherent and accurate and consistent with data at said data center.

18. A method for securely transferring the personality of a postage meter system to a replacement postage meter system at a non-secure location as defined in claim 17 wherein said replacement postage meter system includes a UIC and a PSD and further including the step of said replacement postage meter system PSD securely auditing said installed replacement adjusted data with said data center.

19. A system for securely transferring the personality of a postage meter system, comprising:
a first postage meter system and a second postage meter system;
a data center having data relating to the operation of said first postage meter system;
a security tool having communication functionality for bidirectional secure communications with said first postage meter system, said second postage meter system and said data center;
said security tool connectable to said first postage meter system for secure bidirectional communication between said security tool and said first postage meter system, said security tool connectable to said second postage meter system for secure bidirectional communication with said second postage meter system and said security tool connectable to said data center for secure bidirectional communications with said data center; and,
said security tool operable to extract data from said first postage meter system, securely transmitting said extracted data to said data center, securely receiving replacement adjusted data from said data center and securely communicating said replacement adjusted data to said second postage meter system.

20. A system for securely transferring the personality of a postage meter system as defined in claim 19 wherein said retrieved data from said postage meter system includes data and logs and said data at said data center include data and logs and wherein said data center is operable to process said retrieved data to determining that said retrieved data is coherent and accurate and consistent with data at said data center relating to the operation of said first postage meter system and to employ said retrieved data and said data at said data center relating to the operation of said first postage meter system to create said replacement adjusted data.
